(19) United States
(12) Patent Application Publication
(10) Pub. No.: US 2009/0184123 A1
(43) Pub. Date: Jul. 23, 2009

(54) Receptacle Liner and Method of Manufacture

(76) Inventor: Duane R. Condon, Ramona, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/359,201

(22) Filed: Jan. 23, 2009

Related U.S. Application Data
(60) Provisional application No. 61/011,973, filed on Jan. 23, 2008.

(51) Int. Cl. B65D 25/14; B31B 1/00

(52) U.S. Cl. 220/495.1; 493/267

(57) ABSTRACT

A bag for lining a trash or other receptacle having an interior cavity accessed through an aperture in the elevated rim of the receptacle. The bag features a sealed first end adapted to be positioned at the bottom of the receptacle interior cavity and a sidewall extending to an opening at a second end adapted for positioning on the rim of the receptacle. The opening is formed for a distance less than the diameter of the bag and is stretchable to fit over the rim of the receptacle in a biased engagement therewith.

### FIELD OF THE INVENTION

This application claims the benefit or U.S. Provisional Patent Application Ser. No. 61/011973, filed Jan. 23, 2008, and incorporated herein in its entirety by reference.

The disclosed device relates to waste receptacle liners, such as those employed for residential and commercial trash cans. More particularly, it relates to a trash can liner device adapted for biased engagement to the opening of one or a plurality of different dimensioned receptacles. Employing the method and structure herein, will significantly enhance the quality of the environment and contribute to the conservation of energy resources and oil-derived raw materials. This is achieved through the use of significantly less raw material to produce the finished products, and a significant reduction in the number of models of differently sized plastic bags needed due to the formed device accommodating more sizes of containers or trash receptacles.

### BACKGROUND OF THE INVENTION

In the United States and throughout the world, the lining of trash receptacles employed in kitchens, bathrooms, offices, and other venues, has become ever more popular. For sanitary reasons such liners maintain the surrounding receptacle substantially free from being soiled by the contents of the liner. From a disposal standpoint, such liners make it relatively easy to remove the refuse from the trash receptacle once filled and allow a subsequent deposit into a larger receptacle for transport. Using such a system, the liners are also subsequently easily replaced once a previously-mounted trash-filled liner has been disposed.

The diversity of sizes of such containers in past years has increased as aesthetic and functional considerations of each container has evolved. For instance, bathroom trash receptacles, because of space concerns are relatively small, while kitchen receptacles being positioned in a room with more space, and having to accommodate larger pieces of trash, tend to be larger. However, even in a kitchen venue, such receptacles can come in a number of different dimensions depending on whether they must be placed under a sink, in open view, or in a pantry. Bags employed for containers for yard debris can also vary widely in size depending on whether they must fit a rectangular receptacle or a round one and depending on the volume of each.

As a consequence of this variety of sizes for the receptacles themselves, and a more limited supply of liners adapted to engage a different-sized receptacle, the user is frequently required to employ a liner bag which is too large for the container in which it is engaged. This can be a vexing problem where bags are ill-fitted to their receptacles in a too-loose fashion and subsequently continuously fall into the receptacle. This is especially true in the medical industry where medical waste is being disposed since fixing or remounting a fallen liner requires reaching into the medically-hazardous contents of the liner.

As such, the bag industry has evolved to be required to wastefully produce many types and sizes of receptacle liners in an attempt to accommodate the many differing sizes of the different receptacles in different venues. This production requires more significant energy to produce and refine the plastic raw materials due to the shear number of different-sized bags which are required in inventory for users. Significant energy is wasted by running production lines longer to allow for many different sizes of bags to be produced.

Consequently, by providing a bag that uses less plastic material, and accommodating more container sizes, the method and structure herein provide a more efficient utilization of raw materials, all of which are substantially oil-derived. Further, by using less raw material and by lessening the weight and number of different bag sizes required for production, inventory storage, and shipment by truck or rail, a significant conservation of energy resources is achieved since less energy is employed for both shipment and production of the products.

For convenience and sanitation, users generally wish to line the containers and thus end up with many types and sizes of liners in their homes and businesses. This is inconvenient for users to stock so many different sizes of bags. It is also wasteful of material and energy and hence uneconomical for bag producers to have to accommodate so many different dimensioned containers with a different sized bag. Further, the need to produce and stock and ship so many models of sized plastic bags wastes valuable natural resources and reduces manufacturer profits.

As noted, a consequence of owning a variety of different containers, requires users to buy a supply of each of a number of different-sized bags for their different containers. This occurs even for containers that are almost identical in size since the industry producing the liners has evolved to produce bags that are adapted on one end with a large opening which has an opening size dictated as essentially twice the diameter of the material when laying flat. The bag aperture so formed accommodates the open end of the intended receptacles. A smaller bag will not generally fit a larger receptacle and a bag larger than the intended receptacle will fit loose and be prone to falling into it. Further, much raw material is wasted forming bag openings that are tied or otherwise secured around their the top of intended containers.

Accommodating the different dimensional size for the many receptacles available, where dimensions are determined by various ornamental aspects of such containers, frequently dictates ownership of multiple sizes of such containers for different rooms and purposes. This is true even where industry standard volumes for house and industrial containers such as the 55 gallon containers for yards and the 13 gallon containers used in many kitchens.

Manufacturers trying to accommodate the fairly standard yet varying opening dimensions of such containers conventionally make the bag openings, and hence the bags, larger than necessary. This causes a use of more oil-based plastic raw material to form the circular sheets of material which determine bag size. Further, since consumers like a bag that secures around the opening of the container it fits, manufacturers frequently add draw strings, bands, and other measures to the formed opening in the bag. This allows the formed opening in the bag, to somehow secure around the opening of the container. This however also wastes energy and raw materials since the larger than necessary bags use more material, and are heavier for shipment.

As such, there is an unmet need for a receptacle liner which is adapted to easily engage with a plurality of different dimensioned containers. Such a liner should accommodate containers which are slightly smaller than the diameter of the formed bags easily, and also accommodate containers having openings which are larger than the diameter of the formed bag which generally determines the circumference of the bag opening. Still further, such a receptacle liner should be easily manufactured using current conventional industry production lines. Additionally, the bags so produced to accommodate multiple sized containers should use less raw material to save valuable oil-derived resources. Finally, such a bag liner, by accommodating multiple container sizes and using less raw material, lessening their weight, should concurrently decrease manufacturing costs and the energy needed to manufacture the materials and ship the bags across the country.

### SUMMARY OF THE INVENTION

The disclosed device and method herein provide a trash receptacle liner which is easily manufactured using the currently installed base of manufacturing machinery for forming such receptacle liners. Using the design and method herein to manufacture such liners, the resulting device employs a novel aperture formed between each liner. This novel aperture size, shape, and positioning allow for production in the conventional manner where an elongated ribbon of liners is produced and rendered frangible from adjacent liners.

The formed bags and with the unique aperture in the disclosed device and method, are made frangible from other liners using a perforated line between adjacent receptacle liner bags. The aperture, formed by a cutout and so placed, provides a number of utilitarian functions. First, it makes it easier for users to ascertain the division point between bags in a ribbon or string of bags that is conventionally boxed and unrolled for use. Most users can identify with the task of trying to ascertain where one bag separates from adjacent bags, especially if they are sight-challenged and not wearing glasses. Visually, the aperture provides an easy means to determine the point of separation from adjacent bags.

The aperture formed by the cutout of the sidewall forming the bag, so placed, also functions as means to grip and separate the bag from the adjacent bag in the string by the provision of a handle to tear away the bag from the string of bags provided in a box or container. As such, for users with eyesight problems or lacking the strength to tear conventional bags from a small edge, the aperture forming a handle provides an easy solution to both problems.

Still further, the aperture formed in a first end of the bag liner is configured in a unique shape and a circumference smaller than its intended container. This allows the open end of the bag to be stretched over an open end of the receptacle for which the volume of the bag, is adapted, and thereby form a tight engagement.

Conventional bag liners are produced using plastic sheeting formed in a tube which has an opening with a circumference which is essentially (Pi x the diameter) of the tubing forming the bag. The end opposite the opening formed is sealed forming the bag. The opening so formed conventionally employ strings or elastic in an attempt to hold the bag opening snug to the opening of the container in which it fits.

The device and method herein, by forming an opening in the bag, which is smaller than twice the diameter of the tubing forming the body of the bag, it eliminates the loose engagement problem of conventional plastic bag receptacle liners to their containers. Further, by using a dye to cut a section from the sidewall of the tubing on opposite sides, to form the shape and circumference of the bag opening, the manufacturer may easily dictate the circumference of the formed opening.

Finally, the generally circular aperture formed by the cutout on one end of each bag provides a means to manufacture the bags using less material. Since the formed bag aperture from the cutout is dye cut or otherwise removed from the sidewalls of the formed bag receptacle liner, in a position where conventional plastic bags now employ material, a significant amount of raw material may be recycled into the extrusion process. This is easily accomplished by melting the removed sidewall portions and reusing them in subsequent production. A significant material savings to the manufacturer is thereby provided.

It is thus an object of the invention to provide a plastic bag type receptacle liner which is adapted for engagement to the interior cavity of a receptacle or container and has an opening sized significantly smaller than Pi times the diameter.

It is a further object of this invention to provide an improved trash receptacle liner bag which accommodates containers both larger and smaller than the size for which the bag is designated.

An additional object of this invention is the provision of such an improved liner bag which reduces manufacturing and energy costs by using less raw material and requiring manufacturers to stock, ship, and produce a smaller number of sizes.

Yet another object of this invention is to provide a bag liner which allows the user to easily adapt it to a plurality of containers of differing volumes and having different sized openings to thereby reduce the number of such liners needed.

It is a further object of the invention to provide such a plastic bag in which the formed opening provides an easily perceived visual means to identify a tear point from adjacent bags.

It is yet another object of this invention to provide a handle for a user to grip during separation from an adjacent bag.

It is a further object of the invention to provide such a bag receptacle liner which by employing a smaller opening formed by the cutout, instead of just an open end across the perforation, provides a tight fit to the open end of a receptacle or container when used, alleviating the need for strings or elastic.

These together, with other objects and advantages which will become subsequently apparent, reside in the details of the construction and operation as more fully hereinafter described and claimed, reference being had to the accompanying drawings forming a part thereof, wherein like numerals refer to like parts throughout.

With respect to the above description and background, before explaining at least one preferred embodiment of the invention in detail, it is to be understood that the invention is not limited in its application to the details of construction and to the arrangement of the components and/or steps set forth in the following description or illustrated in the drawings. The various apparatus and methods of the invention herein described and disclosed, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

### BRIEF DESCRIPTION OF DRAWINGS

FIG. 1 depicts the device as manufactured in a string or ribbon of plastic bag receptacle liners formed of plastic tubing showing the formed curved aperture at the perforation point between adjacent bags in the string of bags.

FIG. 2 depicts the device centered in a receptacle with the aperture having a circumference smaller than the receptacle opening, positioned level with the edge of the receptacle opening and ready for stretching over the rim of the receptacle.

FIG. 3 depicts the device wherein the curved aperture as been stretched to an elastic fit over the rim of the receptacle.

### DETAILED DESCRIPTION OF THE PREFERRED EMBODIMENT

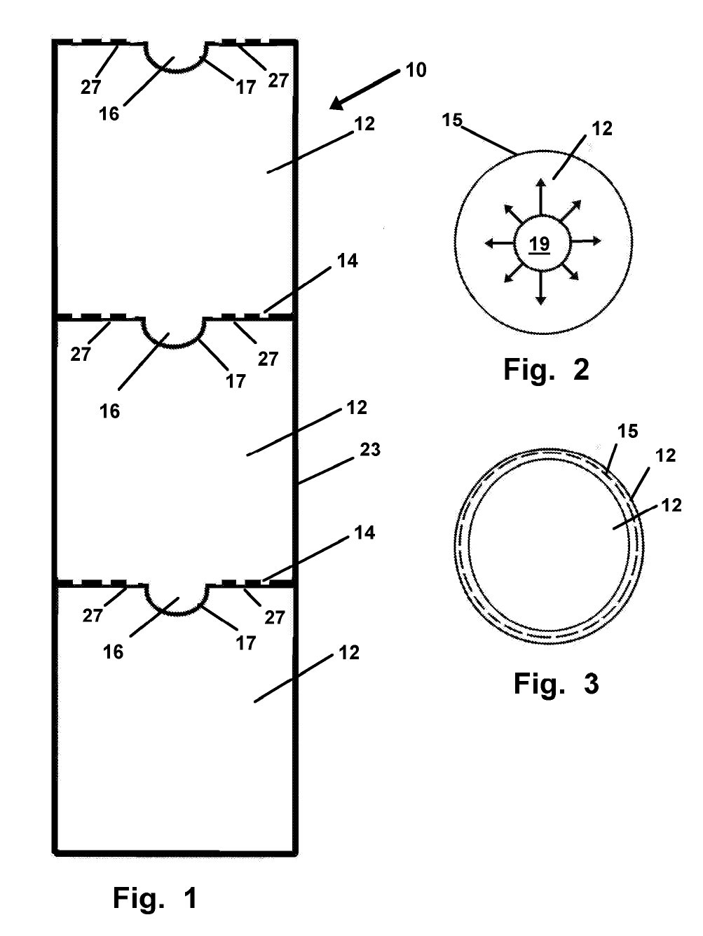

As shown in FIGS. 1-3, the device 10 manufactured by the method herein, employs conventional manufacturing machinery and materials for the formation of such plastic bag 12 receptacle liners. Conventionally such bags 12 are formed of extruded plastic tubing which when laid flat forms a string or ribbon of plastic bags 12. Each conventional bag 12 is formed by a sealing of the sidewalls of the tubing at one end to form a bottom, and leaving the opposite side from the bottom thereby providing a bag opening 19 which is sized substantially as a function of Pi×the diameter of the tubing which was used to make the bag 12. Generally such tubing is chosen with a diameter that provides sidewalls that will be adjacent to the intended container sidewalls, depending on the volume of the intended container.

Unlike a fixed circle, the thin plastic tubing is soft and pliable and may be positioned with its sidewalls folded onto themselves to form a flat double sided ribbon. In such a position, the conventional opening 19 in a formed bag 12 will essentially be formed by a cut across the folded tubing perpendicular to the longitudinal side edge 23. Thus laying flat with both sides of the tubing adjacent, the opening 19 formed in conventional bags, will substantially be double the distance of the perpendicular cut formed across the two adjacent sections of the sidewall of the tubing.

During manufacture, each such bag 12 is made frangible from the other adjacent bags 12, without damage to either, by the employment of cut perforated line 14 which may also serve as the perpendicular cut across both sidewall sections to form the opening 19 and which may also be adjacent to the sealing point forming the bottom of the adjacent bag 12 in the string of bags 12 formed.

In forming the conventional bag 12 for different volume containers manufactures will choose a tubing size, or form a tubing from two sheets of plastic, which has a circumference adapted to fit withing the interior circumference of the intended container. The conventionally formed opening 19 as noted, will be substantially Pi times this tubing circumference, or substantially twice the distance of the perpendicular cut across the adjoining sidewalls folded flat.

In a novel departure from conventional construction noted above, saving both raw material, and energy, a method of production yields the device 10 in the form of the improved bag 12. Using the method to yield the device 10 herein, the bag 12 is provided an opening 19 which is sized to have an opening circumference, which is substantially smaller than the conventional size of Pi times the diameter of the tubing noted above. Instead of employing a perpendicular cut across the axis of the folded tubing sidewalls, an opening 19 having a circumference smaller than Pi times the diameter of the tubing is formed in the resulting bag 12. Using cutting dies or other means to cut an aperture 16 through both adjacent sidewalls of the flattened tubing, such a smaller opening 19 is formed in the resulting bag 12.

The aperture 16 determining the circumference in the opening 19 of the bag, has an edge portion 17, which intersects or is immediately adjacent to the perforation line 14 formed between adjacent bags 12 in the string. As noted, at or adjacent to this perforation line 14, a bottom of the preceding bag 12 is formed by sealing the adjacent flattened sidewalls of the tubing to each other. The distance of this intersecting edge portion 17 cut through both portions of the sidewall of the tubing, defines the circumference of the formed opening 19 in the resulting bag 12.

In a most preferred mode of the device 10 the aperture 16 formed is substantially arch-shaped or curvilinear into both sidewall sections and both have an intersecting at the edge portion 17. Experimentation has shown that an arch-shape of this cutout or some other curved configuration in both adjacent portions of the sidewall, forms the opening 19 in the bag 12 which is stretchable without damage and which can easily be sized to yield an opening 19 in the bag 12 which is smaller than the aperture formed at the rim 15 of the container.

As noted above, conventional bags provide an opening or aperture circumference which is essentially twice the distance across the two sides of the adjacent tubing sidewalls laying flat or Pi times the diameter of the tubing forming the bag 12. This is done by simply cutting across the tubing adjacent to the seal at the perforation line 14 and leaving the edge of the sidewalls of the tubing forming the bag, unsealed. Thus, the circumference of the opening or aperture of conventional trash bags is almost always twice the distance of the flattened adjacent sidewall of the tubing or Pi times the diameter of the tubing. Also noted, because the tubing generally used has a diameter sized to adjoin or touch the walls of the container, the large opening 19 so formed needs elastic or drawstrings on the conventional formed opening 19 to secure it to the rim 15 defining the receptacle opening.

The circumference of the opening 19 formed on the bag 12 by the method herein, is smaller than the circumference of the opening container in which it is to be positioned as in FIG. 2. It has been found that the thickness and elasticity of the material forming the tubing used for the bag 12 will affect the size of the opening 19 so formed. Conventionally, such material mixes are well settled and a favored mode of the device 10 and method herein use a cut to form the aperture 16 which has a circumference distance that is between 20 to 80 percent of a maximum opening circumference distance determined by the diameter of the tubing used times Pi.

Thus the dye or other means to cut the aperture 16 into the adjoining sidewall, will be formed to yield a total circumference of the opening 19 which is between 20 to 80 percent of the potential maximum size of the opening 19 which is determined as Pi times the diameter of the tubing used to form the bag 12. Currently, a particularly preferred mode of the device 10 and method employ a cut to form the aperture 16 having a total circumference of distance between 40-60 percent of the maximum possible size of the opening 19 as determined by the diameter of the tubing used. The bag 12 formed will thus have the opening 19 at the determined sized circumference with intersects a sealed portion 27 at the top of the formed bag 12 extending between the sidewall edge and the intersection of the edge portion 17 of the dye cutout.

By using a cutout to form the opening 19 that is smaller than the circumference of the rim 15 opening of the intended container, the device 10 provides a means to allow a stretching of the elastic plastic material of the bag 12 for a sufficient distance, to provide a biased fit the opening 19 around the rim 15 at the top of most trash containers for which the bag 12 is sized to accommodate. The resulting elastic and biased engagement to the receptacle aperture, defined by the rim 15 shown in FIG. 3, which is provided by this arch shaped cutout yielding the opening 19, on expansion, is tight and accomplished without drawstrings or elastic bands or similar means to bias the opening 19 of the bag to the opening of the trash container or receptacle for use.

Further, in the preferred mode of the device 10 with the arch shaped aperture 16 so formed at the perforation line 14, a visual means to easily identify the separation point of one bag 12 from the next in the string is provided. The edge portion 17 being placed along the perforation line 14, not only provides a user with good or poor eyesight, a visual means to determine the perforation line 14, it also provides a centrally located gripping point for a user to grab and separate the first bag 12 in the string, from the subsequent bag 12 in the string of bags 12. Considering that bags 12 conventionally produced from plastic sheeting are black, or white, or of a constant color throughout the string, it can be hard for a user, to discern separation points of the bags 12 from each other. It can also be hard for users to pinch their fingers or otherwise grip the edges of conventionally produced bags 12 and then tear them along the perforation line 14. This is especially true of older users.

In a method of formation the tubing used to form the bags 12 would be formed by extrusion or other means conventionally employed to form the tubing for a sting of perforated plastic bag liners. The arch-shaped apertures 16 are then die-cut or otherwise formed with the edge portion 17 positioned at or adjacent to a bag separating perforation line 14. The scraps of material from the sidewalls of the bag 12, cut away to form the aperture 16, are collectable and reusable in a means to reduce the amount of material needed for each bag 12.

As noted, currently the arch-shape for the aperture 16 is preferential as the curved sides of the arch of the formed aperture have been found to form a substantially round opening 19, the edges of which stretch more easily around the opening of the rim 15 of the trash receptacle engaged to the bag 12 without tearing. Consequently, an arch shaped aperture 16 forming a substantially oval or round opening 19 in the open end of the produced bag 12 is preferred as a means to prevent tearing and means to provide an opening 19 smaller than the rim 19 of the intended container whereby the material forming the bag 12 may be stretched to a biased engagement on the rim 15.

While all of the fundamental characteristics and features of the receptacle liner and method of manufacture therefor have been disclosed and described, with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth.

It should be understood that such substitutions, modifications, and variations may be made by those skilled in the art without departing from the spirit or scope of the invention. Consequently, all such modifications and variations are included within the scope of the invention as defined herein.

What is claimed is:

1. A receptacle lining bag comprising:
a sidewall extending longitudinally from a first end to a second end;
said first end being sealed;
an interior cavity defined by the area between said first end and said second end of said sidewall;
said interior cavity having a diameter;
an opening formed across a central portion of said second end between two sealed portions at said second end, said opening providing communication into said interior cavity; and
said opening having an opening circumference, said opening circumference being at or between 20-80 percent of said diameter of said interior cavity.

2. The receptacle lining bag of claim 1 additionally comprising:
said opening circumference being at or between 40-60 percent of said diameter of said interior cavity.

3. The receptacle lining bag of claim 1 additionally comprising:
said bag sized for a lining of an interior cavity of a receptacle having a rim having a circumference, said rim providing communication to said interior cavity;
said sidewall formed of elastic material;
said opening circumference being sized smaller than said rim circumference; and
said elastic material providing means to stretch said opening to a biased engagement upon said rim to thereby position said bag in an as-used position within said interior cavity.

4. The receptacle lining bag of claim 2 additionally comprising:
said bag sized for a lining of an interior cavity of a receptacle having a rim having a circumference, said rim providing communication to said interior cavity;
said sidewall formed of elastic material;
said opening circumference being sized smaller than said rim circumference; and
said elastic material providing means to stretch said opening to a biased engagement upon said rim to thereby position said bag in an as-used position within said interior cavity.

5. A method of manufacturing a receptacle lining bag comprising the steps of:
forming a bag sidewall of flexible material surrounding an interior cavity;
forming a seal across the total distance of a first end of said sidewall; and
forming an opening for a distance between 20-80 percent of a total distance across a centrally located portion of a sealed second end of said sidewall opposite said first end, to provide an aperture allowing communication into said interior cavity.

6. The method of manufacturing a receptacle lining bag of claim 5 further comprising the steps of:
forming said opening for said distance between 40-60 percent of said total distance across said second end of said sidewall.

7. The method of manufacturing a receptacle lining bag of claim 5 further comprising the steps of:
forming said opening by cutting said centrally located portion from said sidewall; and
collecting said centrally located portion for a reuse in a subsequent extrusion of subsequent said sidewalls.

8. The method of manufacturing a receptacle lining bag of claim 6 further comprising the steps of:
forming said opening by cutting said centrally located portion from said sidewall at two opposite positions in said second end of said sidewall; and
collecting said centrally located portion for a reuse in a subsequent extrusion of subsequent said sidewalls.

9. A receptacle lining bag comprising:
a sidewall extending longitudinally;
a sealed first end;
an interior cavity defined by the area between said first end an said sidewall;
an opening formed in a centrally located portion of a second end opposite said first end, said second end having a length extending between said sidewall surrounding said interior cavity;
said opening defining an aperture having an aperture diameter and providing a communication through said sidewall into said interior cavity; and
said aperture diameter sized between 20-80 percent of said length of said second end.

10. The receptacle lining bag of claim 9 additionally comprising:
said aperture diameter sized between 40-60 percent of said length of said second end.
